(19) United States
(12) Patent Application Publication
(10) Pub. No.: US 2017/0286379 A1
(43) Pub. Date: Oct. 5, 2017

(54) GENERATING AND RENDERING INFLECTED TEXT

(71) Applicant: Microsoft Technology Licensing, LLC, Redmond, WA (US)

(72) Inventors: Unnati Jigar Dani, Bellevue, WA (US); Jiwon Choi, Seattle, WA (US); David Nissimoff, Bellevue, WA (US); Vineeth Karanam, Redmond, WA (US)

(21) Appl. No.: 15/090,392

(22) Filed: Apr. 4, 2016

(51) Int. Cl. G06F 17/24; G06F 17/21; G06F 3/16; G06F 3/0488

(52) U.S. Cl. CPC G06F 17/24; G06F 3/0488; G06F 17/218; G06F 3/167

(57) ABSTRACT

A facility for using gestures to attach visual inflection to displayed text is described. The facility receives first user input specifying text, and causes the text specified by the first user input to be displayed in a first manner. The facility receives second user input corresponding to a gesture performed with respect to at least a portion of the displayed text, the performed gesture specifying an inflection type. Based at least in part on receiving the second user input, the facility causes the text specified by the first user input to be displayed in a manner that visually reflects application of the inflection type specified by the performed gesture to the at least a portion of the displayed text with respect to which the gesture was performed.

### BACKGROUND

Much human communication is conducted in text, including, for example, email messages, text messages, letters, word processing documents, slideshow documents, etc. The expanding use of electronic devices in human communication tends to further increase the volume of human communication that is conducted in text.

### SUMMARY

This summary is provided to introduce a selection of concepts in a simplified form that are further described below in the Detailed Description. This summary is not intended to identify key factors or essential features of the claimed subject matter, nor is it intended to be used to limit the scope of the claimed subject matter.

A facility for using gestures to attach visual inflection to displayed text is described. The facility receives first user input specifying text, and causes the text specified by the first user input to be displayed in a first manner. The facility receives second user input corresponding to a gesture performed with respect to at least a portion of the displayed text, the performed gesture specifying an inflection type. Based at least in part on receiving the second user input, the facility causes the text specified by the first user input to be displayed in a manner that visually reflects application of the inflection type specified by the performed gesture to the at least a portion of the displayed text with respect to which the gesture was performed.

### BRIEF DESCRIPTION OF THE DRAWINGS

FIG. 1 is a block diagram showing some of the components that may be incorporated in at least some of the computer systems and other devices on which the facility operates.

FIG. 2 is a flow diagram showing a process performed by the facility in some examples to add inflection to text using gestures.

FIGS. 3-10 are display diagrams showing the use of gestures to add visual inflection to text via a variety of examples.

FIG. 11 is a flow diagram showing a process performed by the facility in some examples to add inflection to text using an inflection palette.

FIG. 12-13 are display diagrams showing an example of using an inflection palette to add visual inflection to text.

FIG. 14 is a flow diagram showing a process performed by the facility in some examples to render inflected text to synthesize speech.

### DETAILED DESCRIPTION

The inventors have recognized that textual human communication often does a poor job of conveying emotions connected to the communication, particularly compared to voice communication. For example, the inventors have noted that, in a voice conversation such as a telephone call, differing vocal inflection can make the statement “because it fits” convey different emotions relating to the statement: using relatively high volume can convey excitement; low volume can convey uncertainty; low tone can convey anger; rising tone can convey questioning; etc. In contrast, the textual statement “because it fits” has little capacity to convey such emotions in connection with the statement.

The inventors have further recognized that people who are deaf or otherwise hearing-impaired tend to use textual communication to a great degree, which deprives them of the richer, emotion-inclusive communication available to hearing-unimpaired people via voice communication. Other factors cause hearing-unimpaired people to select textual communication rather than voice communication, including a need to remain quiet, such as in a meeting; the fact that the person to whom the communication is directed is hearing impaired; a desire to be able to more easily reconsider and revise the communication before sending; a mechanism for communicating with the intended recipient that supports textual communication better than or to the exclusion of voice communication; etc.

In view of the foregoing, the inventors have conceived and reduced to practice a hardware and/or software facility for generating and rendering inflected text (“the facility”). In some examples, the facility enables a user to add inflection to text in a textual message, such as by using touch gestures or other gestures corresponding to different inflection types, selecting an inflection type using a palette or menu, or in other ways. As one example of such a gesture, a word may be stretched vertically to emphasize it. Sample inflection types that can be added by the facility include curious, happy, mad, quiet, loud, swelling, excited, and uncertain, among many others.

In some cases, the facility displays inflection added to text as “visual inflection”-a manner of displaying the inflected text that visually reflects the inflection type. As one example, the facility may display a word having emphasis inflection in a larger font. In some examples, the facility displays visual inflection in a real-time or near-real-time manner with respect to performance of the gesture, providing instant or near-instant visual feedback.

In some examples, the facility stores and/or sends inflected text in a way that employs Speech Synthesis Markup Language tags or tags of similar markup languages to represent inflections added to text portions by the facility. As one example, the facility may store and/or send a body of text containing a word having emphasis reflection using the SSML tag <prosody volume=“x-loud”>.

In some examples, the facility renders inflected text as synthesized speech, such as in response to touching it or other user interactions with it. In doing so, the facility causes speech to be synthesized for inflected portions of the text in such a manner as to vocally reflect their inflections.

In some examples, the facility can create, modify, display, speak, send and/or save inflected text in wide variety of applications, such as those for texting, email, textual document generation, diagrammatic document generation, slideshow document generation, diary/notebook generation, managing message boards and comment streams, sending e-cards and electronic invitations, etc. In some examples, the facility transmits inflected text from a first device and/or user to a second device and/or user, enabling the inflected text to be displayed via visual inflection and/or rendered as synthesized speech on the second device and/or to the second user, in this way supporting communication between users via inflected text.

In some examples, the facility uses instances of inflection within inflected text as a basis for assessing the significance of the inflected words within a broader body of text. In some examples, this assessment is sensitive to the particular inflection types used. In various examples, the facility uses these significance assessments in a variety of ways, such as in a process of summarizing the body of text, in a process of evaluating a search query against the body of text, etc.

By performing in some or all of the manners described above, the facility enables people to use textual communications to express and convey emotions connected to the communications.

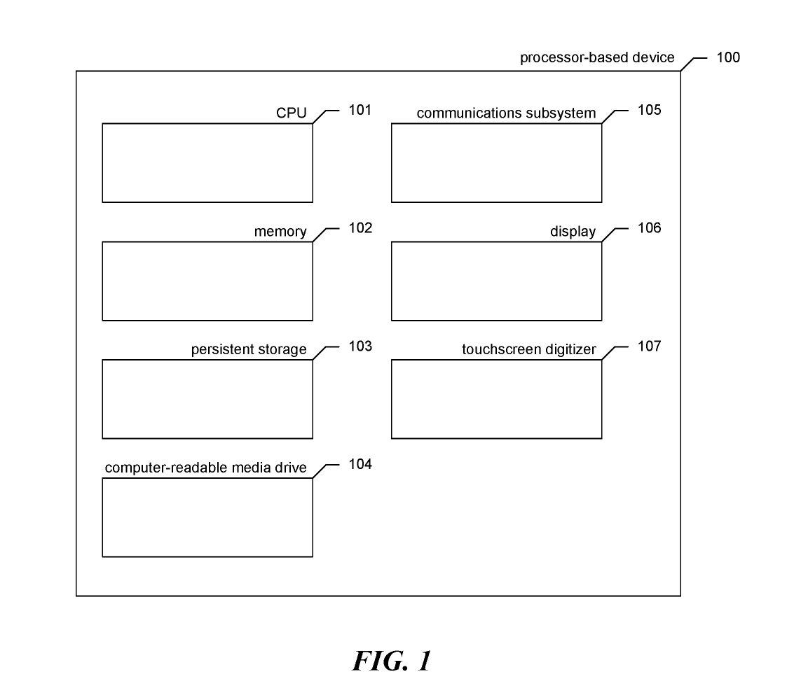

FIG. 1 is a block diagram showing some of the components that may be incorporated in at least some of the computer systems and other devices on which the facility operates. In various examples, these computer systems and other devices 100 can include server computer systems, desktop computer systems, laptop computer systems, tablet computer systems, netbooks, mobile phones, personal digital assistants, televisions, cameras, automobile computers, electronic media players, electronic kiosk devices, electronic table devices, electronic whiteboard devices, etc. In various examples, the computer systems and devices may include any number of the following: a central processing unit (“CPU”) 101 for executing computer programs; a computer memory 102 for storing programs and data while they are being used, including the facility and associated data, an operating system including a kernel and device drivers, and one or more applications; a persistent storage device 103, such as a hard drive or flash drive for persistently storing programs and data; a computer-readable media drive 104, such as a floppy, CD-ROM, or DVD drive, for reading programs and data stored on a computer-readable medium; and/or a communications subsystem 105 for connecting the computer system to other computer systems and/or other devices to send and/or receive data, such as via the Internet or another wired or wireless network and its networking hardware, such as switches, routers, repeaters, electrical cables and optical fibers, light emitters and receivers, radio transmitters and receivers, and the like.

In various examples, these computer systems and other devices 100 may further include any number of the following: a display 106 for presenting visual information, such as text, images, icons, documents, menus, etc.; and a touchscreen digitizer 107 for sensing interactions with the display, such as touching the display with one or more fingers, styluses, or other objects. In various examples, the touchscreen digitizer uses one or more available techniques for sensing interactions with the display, such as resistive sensing, surface acoustic wave sensing, surface capacitance sensing, projected capacitance sensing, infrared grid sensing, infrared acrylic projection sensing, optical imaging sensing, dispersive signal sensing, and acoustic pulse recognition sensing. In some examples, the touchscreen digitizer is suited to sensing the performance of multi-touch and/or single-touch gestures at particular positions on the display. In various examples, the computer systems and other devices 100 include input devices of various other types, such as keyboards, mice, styluses, etc. (not shown).

While computer systems or other devices configured as described above may be used to support the operation of the facility, those skilled in the art will appreciate that the facility may be implemented using devices of various types and configurations, and having various components.

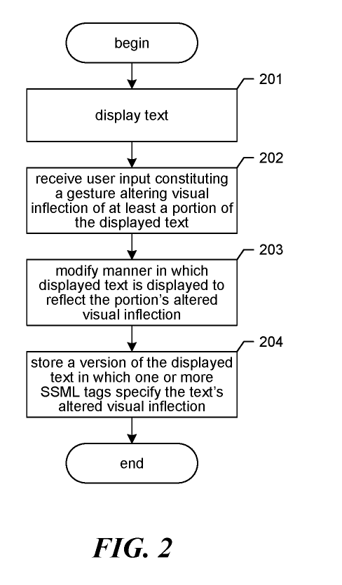

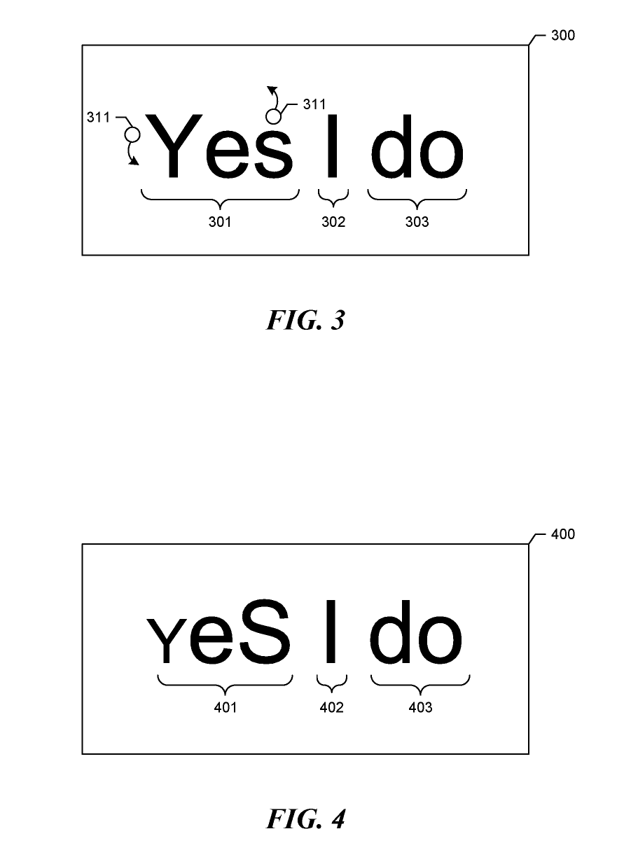

FIG. 2 is a flow diagram showing a process performed by the facility in some examples to add inflection to text using gestures. At 201, the facility displays a body of text. In various examples, the displayed body of text may be text that has been typed, spoken, received, retrieved, etc. At 202, the facility receives user input constituting a gesture for altering the visual inflection of at least a portion of the body of text displayed at 201. FIGS. 3, 5, 7, and 9 discussed below show examples of such gestures. At 203, the facility modifies the manner in which the body of text is displayed to reflect the visual inflection of the portion as altered at 202. FIGS. 4, 6, 8, and 10 discussed below show examples of such modified visual inflections. At 204, the facility stores and/or sends a version of the displayed text in which one or more SSML tags specify the text's altered visual inflection, such as <prosody>SSML tags described in Speech Synthesis Markup Language (SSML) Version 1.1, W3C Recommendation 7 September 2010, available at http://www.w3.org/TR/speech-synthesis11/. After 204, this process concludes. In some examples (not shown), the facility repeats this process one or more additional times to change the visual inflection of the original portion, and/or to add visual inflection to other portions of the body of text.

Those skilled in the art will appreciate that the steps shown in FIG. 2 and in each of the flow diagrams discussed below may be altered in a variety of ways. For example, the order of the steps may be rearranged; some steps may be performed in parallel; shown steps may be omitted, or other steps may be included; a shown step may be divided into substeps, or multiple shown steps may be combined into a single step, etc.

FIGS. 3-10 are display diagrams showing the use of gestures to add visual inflection to text via a variety of examples. FIG. 3 is a display diagram showing a first body of text in a first state. The first state 300 of the first body of text is made up of three words, words 301, 302, and 303. To perform a gesture with respect to word 301, the user establishes two touch points 311 such as by placing his or her thumb and index finger on the display at these points, then rotates these touch points in a counterclockwise direction as shown by the arrows. For example, in some examples, the user performs this gesture in order to add a curious or questioning inflection to this word. In some examples (not shown), the user can perform the opposite gesture, establishing two touch points and rotating them in a clockwise direction.

FIG. 4 is a display diagram showing the first body of text in a second state produced by the gesture shown in FIG. 3. It can be seen in the second state 400 of the first body of text that the gesture has resulted in a visual inflection in which font size increases from the beginning of word 401 through the end of word 401. In some examples, when the facility generates synthesized speech for this body of text, the tone rises throughout the first word of the body of text.

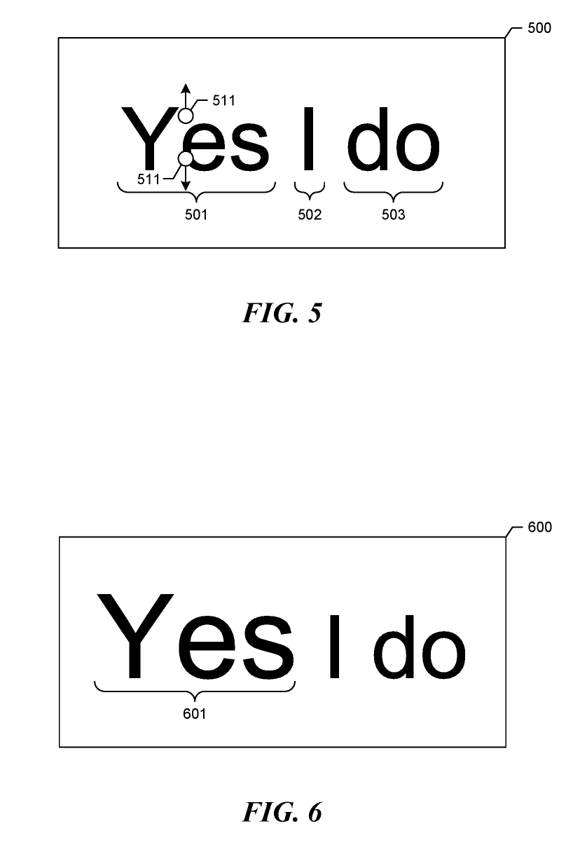

FIG. 5 is a display diagram showing a second body of text in a first state. The first state 500 of the second body of text is made up of three words, 501-503. To perform a gesture with respect to Word 501, the user establishes two touch points 511 defining a line that is substantially vertical, then pushes the touch points farther apart along this substantially vertical line as shown by the arrows. For example, in some examples, the user performs this gesture in order to add certainty inflection to this word. In some examples (not shown), the user can perform the opposite gesture, establishing two touch points defining a substantially vertical line, then drawing the touch points closer together along this line.

FIG. 6 is a display diagram showing the second body of text in a second state produced by the gesture shown in FIG. 5. It can be seen in the second state 600 of the second body of text that the gesture has resulted in a visual inflection in which the font size of word 601 is larger than the font size of the other two words. In some examples, when the facility generates synthesized speech for this body of text, word 601 is spoken in a higher tone than the other two words.

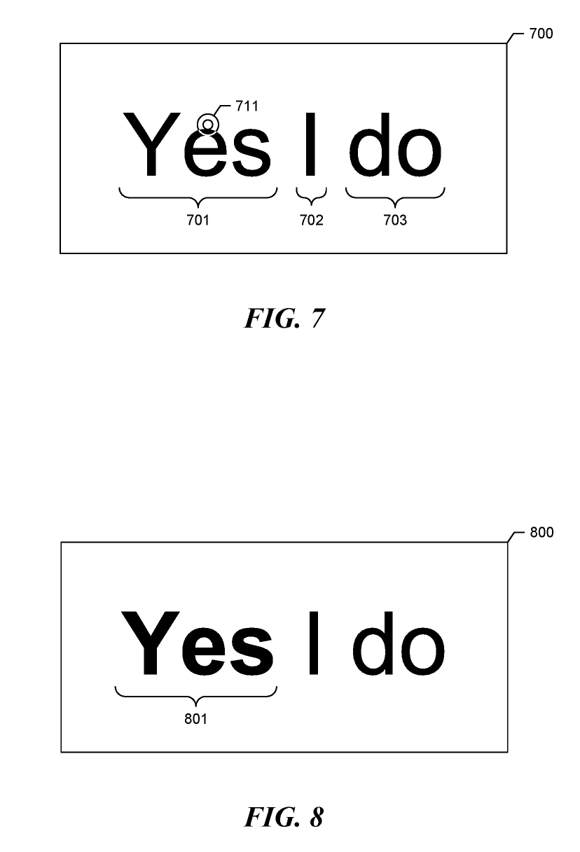

FIG. 7 is a display diagram showing a third body of text in a first state. The first state 700 of the third body of text is made up of three words, 701-703. To perform a gesture with respect to word 701, the user double-taps on touch point 711. For example, in some examples, the user performs this gesture in order to add emphasis inflection to this word.

FIG. 8 is a display diagram showing the third body of text in a second state produced by the gesture shown in FIG. 7. It can be seen in the second state 800 of the third body of text that the gesture has resulted in a visual inflection in which word 801 is bold. In some examples, when the facility generates synthesized speech for this body of text, word 801 is spoken more loudly than the other two words.

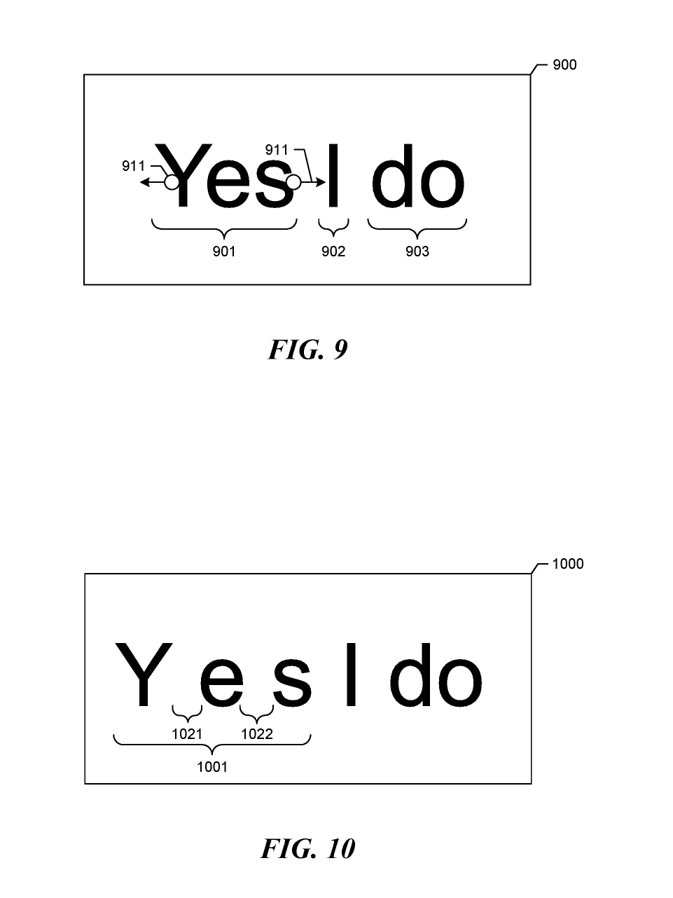

FIG. 9 is a display diagram showing a fourth body of text in a first state. The first state 900 of the fourth body of text is made up of three words, 901-903. To perform a gesture with respect to word 901, the user establishes two touch points 911 defining a line that not substantially vertical—here a line that is substantially horizontal —then pushes the touch points farther apart along this not substantially vertical line as shown by the arrows. For example, in some examples, the user performs this gesture in order to add dwelling inflection to this word. In some examples (not shown), the user can perform the opposite gesture, establishing two touch points defining a line not substantially vertical, then drawing the touch points closer together along this line.

FIG. 10 is a display diagram showing the fourth body of text in a second state produced by the gesture shown in FIG. 9. It can be seen in the second state 1000 of the fourth body of text that the gesture has resulted in a visual inflection in which the letters of word 1001 have greater horizontal separation than the letters of the other two words. In some examples, when the facility generates synthesized speech for this body of text, word 1001 is spoken more slowly than the other two words.

In various examples, the facility enables the use of a wide variety of gestures to add visual inflection to text, including in some cases gestures not shown among FIGS. 3, 5, 7, and 9, and also including in some cases gestures not described herein. In some examples, the facility enables a user to combine multiple gestures, adding together their effects in the resulting visual representation and synthesized speech. In various examples, the facility supports a wide variety of inflection types, having different kinds of linguistic and psychological significance, and represented visually and vocally in various ways, including in some cases some that are not specifically identified herein.

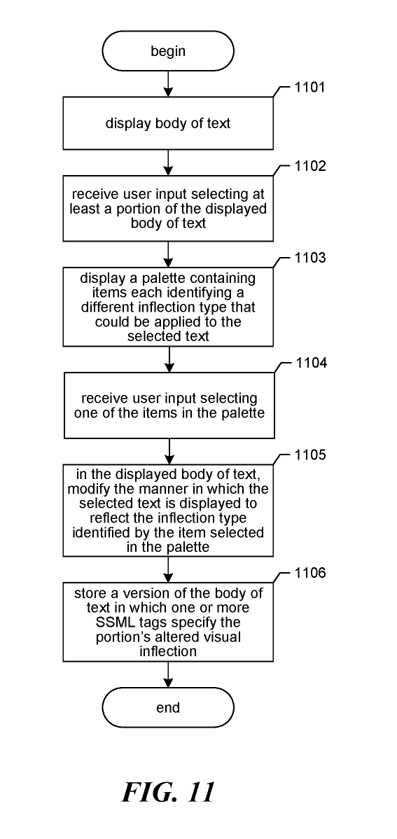

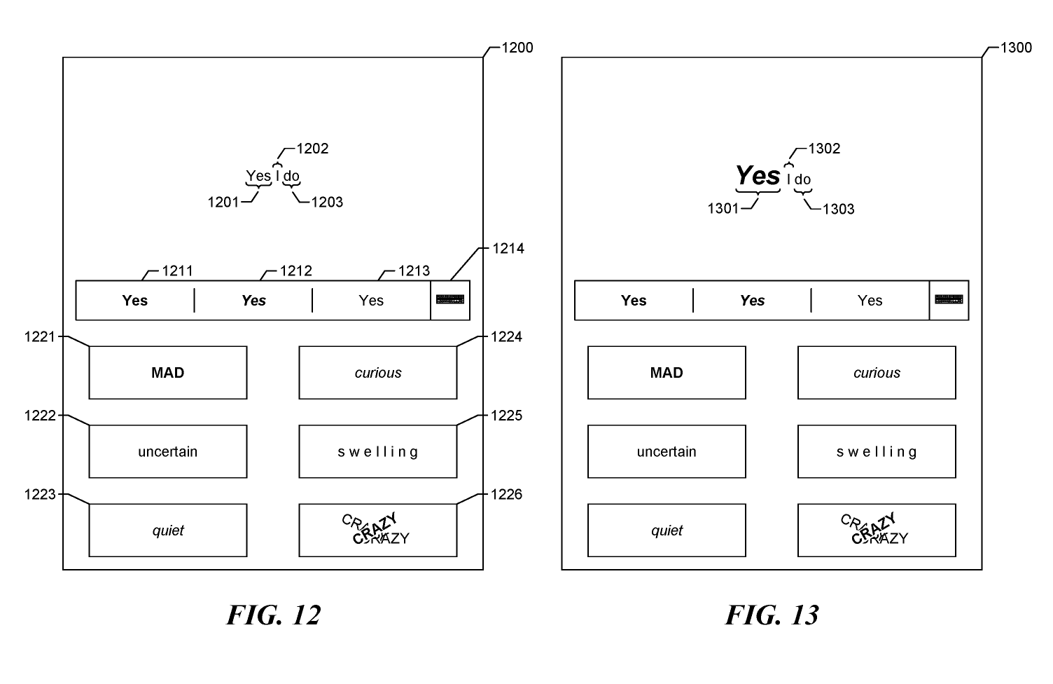

FIG. 11 is a flow diagram showing a process performed by the facility in some examples to add inflection to text using an inflection palette. At 1101, the facility displays a body of text. At 1102, the facility receives user input selecting at least a portion of the displayed body of text, such as by, for example, tapping on a single word constituting the portion; tapping on a first word of the portion than dragging to the last word of the portion; etc. At 1103, the facility displays a palette containing items each identifying a different inflection type that could be applied to the selected text. FIG. 12 discussed below shows an example of such a palette. At 1104, the facility receives user input selecting one of the items in the palette, such as by, for example, tapping on the selected palette item. At 1105, in the displayed body of text, the facility modifies the manner in which the selected portion of text is displayed to reflect the inflection type identified by the selected palette item. An example of this modification is shown in FIG. 13 discussed below. At 1106, the facility stores and/or sends a version of the displayed text in which one or more SSML tags specify the text's altered visual inflection. After 1106, this process concludes. In some examples (not shown), the facility repeats this process one or more additional times to change the visual inflection of the originally-selected portion, and/or to add visual inflection to other portions of the body of text.

FIG. 12-13 are display diagrams showing an example of using an inflection palette to add visual inflection to text. FIG. 12 is a display diagram showing a fifth body of text in a first state, displayed along with an inflection palette. The display 1200 includes the body of text, made up of words 1201-1203. The display further includes a palette made up of palette items 1221-1226. In some cases, some or all of the palette items contain text naming or describing an inflection type. In some cases, some or all the palette items contain text showing the visual inflection formatting corresponding to the inflection type identified by the palette item. In some cases (not shown), at times when text is selected, some or all of the palette items show the selected text having the visual inflection formatting corresponding to the inflection type identified by the palette item. For example, palette item 1221 identifies a “mad” inflection type. In order to add a “mad” inflection to word 1201, the user can touch word 1201, then touch palette item 1221.

FIG. 13 is a display diagram showing the fifth body of text and a second state produced by the interactions described above in connection with FIG. 12. It can be seen that, in display 1300, the facility has added visual inflection for the mad inflection type to word 1301 in response to the interactions discussed above in connection with FIG. 12.

Returning to FIG. 12, in some examples, some or all of the inflection types identified by the palette items 1221-1226 are selected by the facility as likely candidates for a currently-selected portion of the text. In some such examples, the facility selects these candidates on the basis of, for example, (1) the text in the selection, (2) text immediately preceding the selection, (3) text immediately following the selection, etc.

In some examples, the display 1200 also contains a suggestions bar showing suggestion items 1211-1213 each of which corresponds to a different formatting of the selected portion of the body of text. The user can touch one of these suggestion items in order to change the formatting of the selected portion of text to the formatting to which the suggestion item corresponds. In some examples, the display also includes a keyboard button 1214 that the user can activate by touching in order to replace the inflection palette with an on-screen keyboard for entering additional text in the body of text and/or editing text already in the body of text.

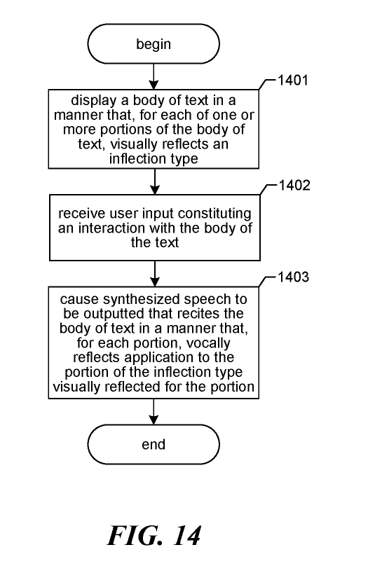

FIG. 14 is a flow diagram showing a process performed by the facility in some examples to render inflected text to synthesize speech. At 1401, the facility displays a body of text in a manner that, for each of one or more portions of the body of text, visually reflects a particular inflection type of that portion. At 1402, the facility receives user input constituting an interaction with the body of text. In some examples, this user input represents the user touching the body of text, performing a different gesture with respect to the body of text, issuing a spoken command, etc. At 1403, the facility causes synthesize speech to be outputted that recites the body of text in a manner that, for each portion, vocally reflects application to the portion of the inflection type visually reflected for the portion in the displayed body of text. In some examples, the facility performs act 1403 by submitting an SSML representation of the displayed body of text to a speech synthesis engine (or “text to speech” engine), such as by invoking the ISpVoice::Speak method of the Microsoft Speech Application Programming Interface described at msdn.microsoft.com/enus/library/ee125024(v=vs/85).aspx. In the case of the ISpVoice::Speak method, the facility passes a pointer to the SSML representation of the body of text as the value of the method's first parameter, pwcs. After 1403, this process concludes.

In some examples, the facility provides a processor-based device, comprising: at least one processor; and memory having contents that, based on execution by the at least one processor, configure the at least one processor to: receive first input from a user specifying text; cause the text specified by the first input to be displayed in a first manner; receive second input from a user corresponding to a gesture performed with respect to some or all of the displayed text, the performed gesture specifying an inflection type; and based at least in part on receiving the second input, cause the text specified by the first input to be displayed in a manner that visually reflects application of the inflection type specified by the performed gesture to the displayed text with respect to which the gesture was performed.

In some examples, the facility provides a computer-readable medium having contents adapted to cause a computing system to: receive first input from a user specifying text; cause the text specified by the first input to be displayed in a first manner; receive second input from a user corresponding to a gesture performed with respect to some or all of the displayed text, the performed gesture specifying an inflection type; and based at least in part on receiving the second input, cause the text specified by the first input to be displayed in a manner that visually reflects application of the inflection type specified by the performed gesture to the displayed text with respect to which the gesture was performed.

In some examples, the facility provides a method comprising: receiving first input from a user specifying text; causing the text specified by the first input to be displayed in a first manner; receiving second input from a user corresponding to a gesture performed with respect to some or all of the displayed text, the performed gesture specifying an inflection type; and based at least in part on receiving the second input, causing the text specified by the first input to be displayed in a manner that visually reflects application of the inflection type specified by the performed gesture to the displayed text with respect to which the gesture was performed.

In some examples, the facility provides a computer-readable medium storing an inflected text data structure, the data structure comprising: a sequence of characters; and for each of one or more contiguous portions of the sequence of characters, an indication of an inflection type specified for the contiguous portion of the sequence of characters by performing a user input gesture with respect to the contiguous portion of the sequence of characters, the contents of the data structure being usable to render the sequence of characters in a manner that reflects, for each of the one or more contiguous portions of the sequence of characters, the inflection type specified for the contiguous portion of the sequence of characters.

In some examples, the facility provides a computer readable medium having contents configured to cause a computing system to: access a representation of a body of text, the representation specifying, for each of one or more portions of the body of text, an inflection type applied to the portion; cause the body of text to be displayed in a manner that, for each portion, visually reflects application of the inflection type specified for the portion to the portion; and cause synthesized speech to be outputted that recites the body of text in a manner that, for each portion, vocally reflects application of the inflection type specified for the portion.

In some examples, the facility provides a processor-based device, comprising: a processor; and a memory having contents that cause the processor to: access a representation of a body of text, the representation specifying, for each of one or more portions of the body of text, an inflection type applied to the portion; cause the body of text to be displayed in a manner that, for each portion, visually reflects application of the inflection type specified for the portion to the portion; and cause synthesized speech to be outputted that recites the body of text in a manner that, for each portion, vocally reflects application of the inflection type specified for the portion.

In some examples, the facility provides a method comprising: accessing a representation of a body of text, the representation specifying, for each of one or more portions of the body of text, an inflection type applied to the portion; causing the body of text to be displayed in a manner that, for each portion, visually reflects application of the inflection type specified for the portion to the portion; and causing synthesized speech to be outputted that recites the body of text in a manner that, for each portion, vocally reflects application of the inflection type specified for the portion.

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

We claim:

1. A processor-based device, comprising:
at least one processor; and
memory having contents that, based on execution by the at least one processor, configure the at least one processor to:
receive first input from a user specifying text;
cause the text specified by the first input to be displayed in a first manner;
receive second input from a user corresponding to a gesture performed with respect to some or all of the displayed text, the performed gesture specifying an inflection type; and
based at least in part on receiving the second input, cause the text specified by the first input to be displayed in a manner that visually reflects application of the inflection type specified by the performed gesture to the displayed text with respect to which the gesture was performed.

2. The device of claim 1, further comprising a touch digitizer, wherein the second input reflects a multi-point touch gesture sensed by the touch digitizer.

3. The device of claim 1 wherein the gesture to which the received second input corresponds is horizontal pinch in, horizontal pinch out, non-horizontal pinch in, non-horizontal pinch out, vertical pinch in, vertical pinch out, tap, double tap, flick up, flick down, curve, or skew.

4. The device of claim 1 wherein the inflection type specified by the performed gesture is curious, happy, mad, quiet, loud, swelling, excited, or uncertain.

5. The device of claim 1, further comprising a speaker, the memory having contents that, based on execution by the at least one processor, configure the at least one processor to further:
cause synthesized speech to be played by the speaker that recites the specified text in a manner that vocally reflects application of the inflection type specified by the performed gesture to the displayed text with respect to which the gesture was performed.

6. The device of claim 1, the memory having contents that, based on execution by the at least one processor, configure the at least one processor to further:
store in the memory in Speech Synthesis Markup Language format a representation of the specified text in which the displayed text with respect to which the gesture was performed is demarcated with a tag specifying the inflection type specified by the performed gesture.

7. The device of claim 1, the memory having contents that, based on execution by the at least one processor, configure the at least one processor to further:
after receiving the first input and before receiving the second input, receiving third input from a user selecting the displayed text with respect to which the gesture is performed.

8. The device of claim 1 wherein causing the text specified by the first input to be displayed in a manner that visually reflects application of the inflection type is performed substantially in real-time relative to receiving the second user input.

9. The device of claim 1, the memory having contents that, based on execution by the at least one processor, configure the at least one processor to further:
include the text specified by the first input, qualified by the inflection type specified by the performed gesture, to be included in a message transmitted from the processor-based device to a second processor-based device, enabling the second processor-based device to (1) display the text specified by the first input in a manner that visually reflects application of the inflection type specified by the performed gesture to the displayed text with respect to which the gesture was performed, and (2) output synthesized speech that recites the body of text in a manner that vocally reflects application of the inflection type specified by the performed gesture to the displayed text with respect to which the gesture was performed.

10. The device of claim 1, the memory having contents that, based on execution by the at least one processor, configure the at least one processor to further:
based at least in part on the inflection type specified by the performed gesture, determine a value reflecting the importance of the displayed text with respect to which the gesture was performed within the displayed text; and
evaluate a search query against the displayed text in a manner that considers the determined value.

11. A computer-readable medium storing an inflected text data structure, the data structure comprising:
a sequence of characters; and
for each of one or more contiguous portions of the sequence of characters, an indication of an inflection type specified for the contiguous portion of the sequence of characters by performing a user input gesture with respect to the contiguous portion of the sequence of characters, the contents of the data structure being usable to render the sequence of characters in a manner that reflects, for each of the one or more contiguous portions of the sequence of characters, the inflection type specified for the contiguous portion of the sequence of characters.

12. The computer-readable medium of claim 11 wherein the indications of inflection types each comprise a set of one or more Speech Synthesis Markup Language tags.

13. The computer-readable medium of claim 11 wherein, for a distinguished one of the contiguous portions, the indicated inflection type reflects an automatic inference as to inflection type based upon at least content of the distinguished portion.

14. The computer-readable medium of claim 11 wherein, for a distinguished one of the contiguous portions, the indicated inflection type reflects an automatic inference as to inflection type based upon at least (1) content of the distinguished portion, and (2) one or words preceding the distinguished portion in the sequence.

15. A computer readable medium having contents configured to cause a computing system to:
access a representation of a body of text, the representation specifying, for each of one or more portions of the body of text, an inflection type applied to the portion;
cause the body of text to be displayed in a manner that, for each portion, visually reflects application of the inflection type specified for the portion to the portion; and
cause synthesized speech to be outputted that recites the body of text in a manner that, for each portion, vocally reflects application of the inflection type specified for the portion.

16. The computer readable medium of claim 15 wherein the synthesized speech is caused to be outputted at least in part based on receiving user input corresponding to an interaction with the displayed body of text.

17. The computer readable medium of claim 15 wherein the synthesized speech is caused to be outputted at least in part based on (1) receiving user input corresponding to selecting the displayed body of text, (2) receiving user input corresponding to touching the displayed body of text, (3) receiving user input corresponding to selecting a visual user interface control displayed in connection with the body of text, (4) receiving user input corresponding to touching a visual user interface control displayed in connection with the body of text, or (5) receiving the representation of the body of text from another device.

18. The computer readable medium of claim 15 wherein causing synthesized speech to be outputted comprises calling a text-to-speech API function, passing parameters separately specifying portions of the body of text and the inflection type specified for each portion.

19. The computer readable medium of claim 15 wherein causing synthesized speech to be outputted comprises calling a text-to-speech API function, passing a version of the body of text containing markup language tags conveying the inflection type specified for each portion.

20. The computer readable medium of claim 15 wherein, for a selected one of the portions of the body of text, the inflection type specified by the representation was selected from a palette of inflection types.
